(19) United States
(12) Patent Application Publication
(10) Pub. No.: US 2025/0373190 A1
(43) Pub. Date: Dec. 4, 2025

(54) HIGH-STRENGTH STEEL COLD-FORMED PROFILE FOR PHOTOVOLTAIC MODULE FRAME AND PHOTOVOLTAIC MODULE FRAME

(71) Applicant: JIANGSU HUISHAN NEW ENERGY GROUP CO., LTD., Wuxi (CN)

(72) Inventors: Yebin RUI, Wuxi (CN); Ruizhen MING, Wuxi (CN); Jianwei XU, Wuxi (CN)

(73) Assignee: JIANGSU HUISHAN NEW ENERGY GROUP CO., LTD., Wuxi (CN)

(21) Appl. No.: 18/875,189

(22) PCT Filed: Oct. 20, 2022
(86) PCT No.: PCT/CN2022/126371

§ 371 Date: Dec. 16, 2024

(30) Foreign Application Priority Data
Jun. 15, 2022 (CN) 202210671959.2
Jun. 15, 2022 (CN) 202221481529.6

(51) Int. Cl. H02S 20/20; F16B 5/12

(52) U.S. Cl. CPC H02S 20/20; F16B 5/121

(57) ABSTRACT

The provided is a high-strength steel cold-formed profile for a photovoltaic module frame and a photovoltaic module frame. The photovoltaic module frame includes: a large U-shaped portion; a small U-shaped portion embedded in the large U-shaped portion; an L-shaped portion connected to a lower side of the small U-shaped portion, the large U-shaped portion, the small U-shaped portion, and the L-shaped portion forming a cavity; wherein a small upper vertical wall and a small horizontal wall of the small U-shaped portion are respectively abutted against a large upper vertical wall and an upper part of a large horizontal wall of the large U-shaped portion; and the small horizontal wall of the small U-shaped portion and the large horizontal wall of the large U-shaped portion are fastened and connected at their overlapping part by a predetermined interlayer welding structure.

### TECHNICAL FIELD

The present invention relates to the fields of new energy and photovoltaic devices, and in particular to a high-strength steel cold-formed profile for supporting and bearing a photovoltaic module frame and a photovoltaic module frame.

### BACKGROUND TECHNOLOGY

It is well known in the photovoltaic module production and application industry that a photovoltaic module is composed of laminates and frames on the edges of the laminates. The frame is rectangular and is spliced by four frame profiles and four corners. The profiles are the main components of the photovoltaic module frame. Chinese Patent No. 202122813907.8 discloses a photovoltaic module frame, in which a frame profile includes an outer side portion and an inner side portion. The outer side portion includes a large U-shaped portion arranged horizontally with its open side facing inward. The inner side portion includes a small U-shaped portion for accommodating an edge of a laminate of a photovoltaic module. A small upper vertical wall and a small horizontal wall of the small U-shaped portion are overlapped in a free manner with a large upper vertical wall and a part of an upper part of a large horizontal wall of the large U-shaped portion, respectively. An L-shaped portion is located below the small U-shaped portion, and an upper edge of a vertical wall of the L-shaped portion is integrated with an outer edge of the small lower vertical wall of the small U-shaped portion. Thus, a cavity is formed by the small lower vertical wall of the small U-shaped portion and a large part of a large lower vertical wall of the large U-shaped portion on an opposite side, as well as the vertical wall of the L-shaped portion and a large part of the large horizontal wall of the large U-shaped portion on an opposite side. An outer edge of the large lower vertical wall of the large U-shaped portion and an outer edge of the horizontal wall of the L-shaped portion both have extended edges, wherein the extended edge of the outer edge of the large lower vertical wall is longer than the extended edge of the outer edge of the horizontal wall of the L-shaped portion, and the two extended edges are loosely stacked together. During processing, an outer edge of the extended edge of the outer edge of the large lower vertical wall is first bent upward and inward by 180 degrees and wrapped on the extended edge of the outer edge of the horizontal wall of the L-shaped portion, and then bent upward and inward by 180 degrees together, so that an upper protrusion is formed between the outer edge of the large lower vertical wall of the large U-shaped portion and the outer edge of the horizontal wall of the L-shaped portion. A thickness of the upper protrusion is three times a thickness of the extended edge of the outer edge of the large lower vertical wall or a thickness of the extended edge of the outer edge of the horizontal wall of the L-shaped portion.

After the small upper vertical wall of the small U-shaped portion is overlapped with the large upper vertical wall of the large U-shaped portion, an inner surface of the small upper vertical wall of the small U-shaped portion is still a plane perpendicular to its small lower horizontal wall. When the edge of the laminate of the photovoltaic module is mounted into the small U-shaped portion, it is necessary to first add a sealant into the small U-shaped portion, and then mount the edge of the laminate into the small U-shaped portion. During the mounting, the sealant in the small U-shaped portion is squeezed and overflows from the gap between the small U-shaped portion and the laminate. As a result, the sealant in the small U-shaped portion cannot reach between the small upper vertical wall and the upper side surface of the laminate. When it rains, rainwater would enter between the small upper vertical wall and the upper side surface of the laminate. Therefore, the photovoltaic module using such a profile has poor sealing performance and a short service life.

Furthermore, since the small upper vertical wall and the small horizontal wall of the small U-shaped portion are freely abutted against the large upper vertical wall and a part of the upper part of the large horizontal wall of the large U-shaped portion, respectively, without fixing means therebetween, only the small U-shaped portion and the L-shaped portion constituting an inner side portion bear the weight of the laminate, leading to poor rigidity and low strength of such a profile.

Furthermore, since the extended edge of the outer edge of the large lower vertical wall and the extended edge of the outer edge of the horizontal wall of the L-shaped portion are loosely stacked together without fixing means therebetween, which further reduces the rigidity and strength of such a profile.

Furthermore, since an upper protrusion, the thickness of which is three times the thickness of the extended edge of the outer edge of the large lower vertical wall or the thickness of the extended edge of the outer edge of the horizontal wall of the L-shaped portion is formed between the outer edge of the large lower vertical wall of the large U-shaped portion and the outer edge of the horizontal wall of the L-shaped portion, in order to leave enough mounting positions for fixing bolts in the upper protrusion to facilitate fixing of the profile on a bracket, it is necessary to increase the widths of the extended edge of the outer edge of the large lower vertical wall and the extended edge of the outer edge of the horizontal wall of the L-shaped portion. However, increasing the widths of the extended edge of the outer edge of the large lower vertical wall and the extended edge of the outer edge of the horizontal wall of the L-shaped portion increases the amount of steel used, resulting in increase in the manufacturing cost of the profile and higher production cost.

Furthermore, the existing photovoltaic module frame has insufficient strength. Especially when it is long, it cannot effectively resist torque. Due to its poor torsion resistance, it is easily deformed when subjected to torque, causing damage to the module surface.

### Content of the Invention

The problem to be solved by the present invention is to overcome the above-mentioned shortcomings and provide a high-strength steel cold-formed profile for a photovoltaic module frame and a photovoltaic module frame. The high-strength steel cold-formed profile for a photovoltaic module frame has high rigidity, high strength and low production cost. Use of the high-strength steel cold-formed profile for a photovoltaic module frame can improve the sealing performance of the photovoltaic module and extend the service life of the photovoltaic module.

The above-mentioned problem to be solved by the present invention is achieved by the following technical solutions.

A high-strength steel cold-formed profile for a photovoltaic module frame of the present invention includes an outer side portion and an inner side portion. The outer side portion includes a large U-shaped portion arranged horizontally with its open side facing inward. The inner side portion includes a small U-shaped portion for accommodating an edge of a laminate of a photovoltaic module. A small upper vertical wall and a small horizontal wall of the small U-shaped portion are overlapped in a free manner with a large upper vertical wall and an upper part of a large horizontal wall of the large U-shaped portion, respectively. An L-shaped portion is located below the small U-shaped portion, and an upper edge of a vertical wall of the L-shaped portion is integrated with an outer edge of the small lower vertical wall of the small U-shaped portion. Thus, a cavity is formed by the small lower vertical wall of the small U-shaped portion and a large part of a large lower vertical wall of the large U-shaped portion on an opposite side, as well as the vertical wall of the L-shaped portion and a large part of the large horizontal wall of the large U-shaped portion on an opposite side. The high-strength steel cold-formed profile for a photovoltaic module frame is characterized in that welding points are evenly distributed longitudinally on the small horizontal wall of the small U-shaped portion and the corresponding large horizontal wall of the large U-shaped portion; and the large lower vertical wall of the large U-shaped portion has an extended edge on an outer edge thereof, and welding points are evenly distributed longitudinally on the extended edge and a horizontal wall of the L-shaped portion.

A further modification of the present invention is that the extended edge and the horizontal wall of the L-shaped portion are integrated with each other in an overlapping manner, so that the horizontal wall of the L-shaped portion is parallel to the extended edge of the outer edge of the large lower vertical wall.

A further modification of the present invention is that the large upper vertical wall of the large U-shaped portion has, on an outer edge thereof, an outer convex edge protruding from the outer edge of the small upper vertical wall of the small U-shaped portion, and the outer convex edge is bent downward and inward by 180 degrees to form a rim under the outer edge of the small upper vertical wall of the small U-shaped portion, so that a sealant overflow gap is formed between the small upper vertical wall of the small U-shaped portion within the rim and an upper surface of the edge of the laminate of the photovoltaic module during mounting.

A further modification of the present invention is that the small upper vertical wall of the small U-shaped portion corresponding to the outer edge of the rim and the large upper vertical wall of the large U-shaped portion corresponding to the outer edge of the rim both have a downward inclination angle in a longitudinal direction.

Specifically, the downward inclination angle is not greater than 10 degrees.

An optimal angle of the downward inclination angle is 10 degrees.

The cavity has a rectangular cross section and its height is greater than its width.

The cross section of the cavity may be square.

Another aspect of the present invention provides a photovoltaic module frame, comprising:
a large U-shaped portion; a small U-shaped portion embedded in the large U-shaped portion; an L-shaped portion connected to a lower side of the small U-shaped portion, the large U-shaped portion, the small U-shaped portion, and the L-shaped portion forming a cavity; wherein
a small upper vertical wall and a small horizontal wall of the small U-shaped portion are respectively abutted against a large upper vertical wall and an upper part of a large horizontal wall of the large U-shaped portion;
the small horizontal wall of the small U-shaped portion and the large horizontal wall of the large U-shaped portion are fastened and connected at their overlapping part by a predetermined interlayer welding structure; and
a large lower vertical wall of the large U-shaped portion has an extended edge on an outer edge thereof, and the extended edge and the horizontal wall of the L-shaped portion are fastened and connected at their overlapping part by a predetermined interlayer welding structure.

Further, the predetermined interlayer welding structure is an interlayer connection structure formed by welding a first surface material and a second surface material at their overlapping part; wherein a welding depth of a welding area in the second surface material is controlled to be less than a predetermined depth.

Further, the predetermined depth is less than a thickness of the second surface material, and a welding direction is from the first surface material to the second surface material.

Further, the predetermined interlayer welding structure is in a form of a complete straight line segment, multiple straight line segments distributed at intervals, multiple complete straight line segments arranged in parallel, or multiple straight line segments distributed at intervals and arranged in parallel; or a combination of a complete straight line segment and multiple straight line segments distributed at intervals and arranged in parallel; or
the predetermined interlayer welding structure is in a form of a zigzag line, an S-shaped line, or a dotted distribution.

Further, the large upper vertical wall of the large U-shaped portion has, on an outer edge thereof, an outer convex edge protruding from an outer edge of the small upper vertical wall of the small U-shaped portion, and the outer convex edge is bent to wrap around the small upper vertical wall of the small U-shaped portion to form a rim, so that an sealant overflow gap is formed between the small upper vertical wall of the small U-shaped portion within the rim and an upper surface of the edge of the laminate of the photovoltaic module during mounting.

Further, the large U-shaped portion, the small U-shaped portion, and the L-shaped portion are integrally formed using a piece of plate, wherein the horizontal wall of the L-shaped portion and the extended edge of the large U-shaped portion are an overlapping structure formed by folding a plate in half; and ends of the folded plate on both sides finally converge and is connected with each other at the rim.

Further, the plate is a steel plate or a magnesium-aluminum-zinc-plated steel plate.

Further, the depth of the welding area in the second surface material is controlled so that the second surface material has no protrusions on its outer wall.

Further, the small U-shaped portion accommodates the edge of the laminate of the photovoltaic module, and an L-shaped portion is located below the small U-shaped portion; the L-shaped portion is connected to the lower side of the small U-shaped portion, and the large U-shaped portion, the small U-shaped portion, and the L-shaped portion form a cavity, which means:
a cavity is formed by the small lower vertical wall of the small U-shaped portion and the large lower vertical wall of the large U-shaped portion on an opposite thereof, as well as the vertical wall of the L-shaped portion and the large horizontal wall of the large U-shaped portion on an opposite thereof.

Further, the predetermined depth is ½ or ⅓ of the thickness of the second surface material; or the predetermined depth is less than ⅘ of the thickness of the second surface material.

Further, the welding method includes arc welding and laser welding.

Further, the welding direction is from the first surface material to the second surface material, which specifically includes:
welding the overlapping part of the small horizontal wall of the small U-shaped portion and the large horizontal wall of the large U-shaped portion from a side of the small horizontal wall of the small U-shaped portion to a side of the large horizontal wall of the large U-shaped portion; and
welding the overlapping part of the extended edge and the horizontal wall of the L-shaped portion from the horizontal wall of the L-shaped portion to the extended edge.

### Advantageous Effects of the Invention

1. The present invention provides a high-strength steel cold-formed profile for a photovoltaic module frame and a photovoltaic module frame. Since welding points are evenly distributed longitudinally on the extended edge of the outer edge of the large lower vertical wall of the large U-shaped portion and the horizontal wall of the L-shaped portion, they are fixed together, thereby further improving the rigidity and strength of the high-strength steel cold-formed profile for a photovoltaic module frame of the present invention.
2. Furthermore, since the large upper vertical wall of the large U-shaped portion has, on the outer edge thereof, the outer convex edge protruding from the outer edge of the small upper vertical wall of the small U-shaped portion, and the outer convex edge is bent downward and inward by 180 degrees to form a rim under the outer edge of the small upper vertical wall of the small U-shaped portion, a sealant overflow gap is formed between the small upper vertical wall of the small U-shaped portion within the rim and the upper surface of the edge of the laminate of the photovoltaic module during mounting, so that the sealant fills the gap between the small upper vertical wall of the small U-shaped portion and the upper surface of the edge of the photovoltaic module. Hence, the situation where rainwater enters between the small upper vertical wall and the upper side surface of the laminate on rainy days is avoided, thereby improving the sealing performance of the photovoltaic module and extending the service life of the photovoltaic module.
3. Furthermore, since the sealant is prevented from overflowing between the small upper vertical wall of the small U-shaped portion and the laminate, not only is the appearance quality of the photovoltaic module improved, but also the power generation efficiency of the photovoltaic module is improved.
4. Furthermore, since the extended edge of the large lower vertical wall of the large U-shaped portion and the horizontal wall of the L-shaped portion are integrally connected in an overlapping manner, the horizontal wall of the L-shaped portion is parallel to the extended edge of the outer edge of the large lower vertical wall. Compared with the technique in the art, the horizontal wall of the L-shaped portion and the outer edge of the extended edge of the outer edge of the large lower vertical wall have no upper protrusions, eliminating the need to increase the widths of the outer edge of the large lower vertical wall and the outer edge of the horizontal wall of the L-shaped portion, which not only facilitates mounting, but also reduces the amount of steel used and reduces production cost.
5. Since welding points are evenly distributed longitudinally on the small horizontal wall of the small U-shaped portion and the corresponding part of the large horizontal wall of the large U-shaped portion, the small horizontal wall of the small U-shaped portion and the corresponding part of the large horizontal wall of the large U-shaped portion are fixed together longitudinally by welding, and thus the weight of the photovoltaic module is borne by the small horizontal wall of the small U-shaped portion on the inner side and the corresponding part of the large horizontal wall of the large U-shaped portion together. Compared with the technique in the art, the rigidity and strength of the high-strength steel cold-formed profile for a photovoltaic module frame of the present invention are greatly improved.
6. In addition, the present invention can significantly enhance the strength and torsion resistance of the photovoltaic module frame by arranging the interlayer welding structure in the form of a complete straight line segment or multiple straight line segments distributed at intervals between the small horizontal wall of the small U-shaped portion and the corresponding part of the large horizontal wall of the large U-shaped portion in the longitudinal direction. Further, for the interlayer welding structure at the overlapping part of the extended edge and the horizontal wall of the L-shaped portion, the horizontal wall of the L-shaped portion is welded and connected with the extended edge through the interlayer welding structure, thereby further enhancing the strength of the frame. Provision of the two interlayer welding structures enhances the strength of the frame in both the vertical and horizontal directions, so that the frame has a stronger torsion resistance, and the overall strength of the frame is further improved.
7. The interlayer welding structure of the present invention is achieved by welding from the first surface material to the second surface material, and the welding depth of the welding area in the second surface material is controlled to be less than a predetermined depth, thereby ensuring that the outside of the second surface material is not distorted due to the welding points, leading to higher shape accuracy.

### DESCRIPTION OF THE DRAWINGS

FIG. 1 is a schematic view of the cross-sectional structure of a high-strength steel cold-formed profile for a photovoltaic module frame of the present invention;

FIG. 2 is a schematic right side view of FIG. 1;

FIG. 3 is a schematic top view of FIG. 1;

FIG. 4 is a schematic view showing the position of an interlayer welding structure of a photovoltaic module frame according to an embodiment of the present invention;

FIG. 5 is a schematic view of an interlayer welding structure in the form of a complete straight line segment;

FIG. 6 is a schematic view of the cross-section at the A-A position;

FIG. 7 is a schematic view of the cross-sectional view of the A-A position rotated 90 degrees to the left;

FIG.8 is a schematic view of an interlayer welding structure in the form of multiple straight line segments distributed at intervals;

FIG. 9 is an A-A position cross-sectional view of an interlayer welding structure of multiple straight line segments distributed at intervals;

FIG. 10 is a schematic view of an interlayer welding structure of multiple complete straight line segments arranged in parallel;

FIG. 11 is a schematic view of a combination of a complete straight line segment and straight line segments distributed at intervals at both sides;

FIG. 12 is a schematic view of an interlayer welding structure in the form of a zigzag line;

FIG. 13 is a schematic view of an interlayer welding structure in the form of an S-shaped line.

### SPECIFIC IMPLEMENTATIONS

The technical solutions in the embodiments of the present invention will be clearly and completely described below with reference to the drawings in the embodiments of the present invention. It is obvious that the described embodiments are merely part of the embodiments of the present invention, rather than all the embodiments. Based on the embodiments of the present invention, all other embodiments obtained by those of ordinary skill in the art without creative work are within the protective scope of the present invention.

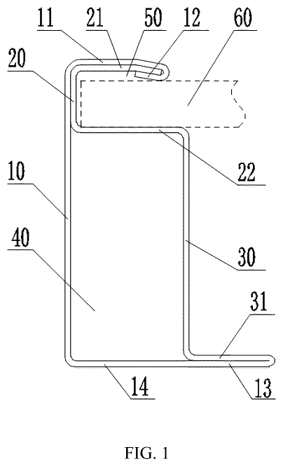

As shown in FIG. 1, a high-strength steel cold-formed profile for a photovoltaic module frame of the present invention includes an outer side portion and an inner side portion. The outer side portion includes a large U-shaped portion arranged horizontally with its open side facing inward. The inner side portion includes a small U-shaped portion for accommodating an edge of a laminate 60 of the photovoltaic module. A small upper vertical wall 21 and a small horizontal wall 20 of the small U-shaped portion are freely abutted against a large upper vertical wall 11 and an upper part of a large horizontal wall 10 of the large U-shaped portion, respectively. The large upper vertical wall 11 of the large U-shaped portion is provided by processing with, on an outer edge thereof, an outer convex edge protruding from the outer edge of the small upper vertical wall 21 of the small U-shaped portion, and the outer convex edge is bent downward and inward by 180 degrees to form a rim 12 under the outer edge of the small upper vertical wall 21 of the small U-shaped portion. And, the small upper vertical wall 21 of the small U-shaped portion corresponding to the outer edge of the rim 12 and the large upper vertical wall 11 of the large U-shaped portion corresponding to the outer edge of the rim are both provided by processing with a downward inclination angle in a longitudinal direction. The downward inclination angle can be any angle not greater than 10 degrees. In this embodiment, the downward inclination angle is 10 degrees. With formation of the rim 12 under the outer edge of the small upper vertical wall 21 of the small U-shaped portion, and longitudinally forming the downward inclination angle on the small upper vertical wall 21 of the small U-shaped portion corresponding to the outer edge of the rim 12 and the large upper vertical wall 11 of the large U-shaped portion, a sealant overflow gap 50 is formed between the small upper vertical wall 21 of the small U-shaped portion within the rim 12 and the upper surface of the edge of the laminate 60 of the photovoltaic module, thereby improving the sealing performance of the photovoltaic module, avoiding the occurrence of rainwater entering between the small upper vertical wall 21 and the upper side surface of the photovoltaic module on rainy days, and extending the service life of the photovoltaic module.

An L-shaped portion is provided below the small U-shaped portion, and an upper edge of a vertical wall 30 of the L-shaped portion is integrated with an outer edge of the small lower vertical wall 22 of the small U-shaped portion. Thus, a cavity 40 is formed by the small lower vertical wall 22 of the small U-shaped portion and a part of a large lower vertical wall 14 of the large U-shaped portion on an opposite side, as well as the vertical wall 30 of the L-shaped portion and a large part of of the large horizontal wall 10 of the large U-shaped portion on an opposite side. The cross section of the cavity 40 may be rectangular or square. In this embodiment, the cross section of the cavity 40 is rectangular, and its height is greater than its width.

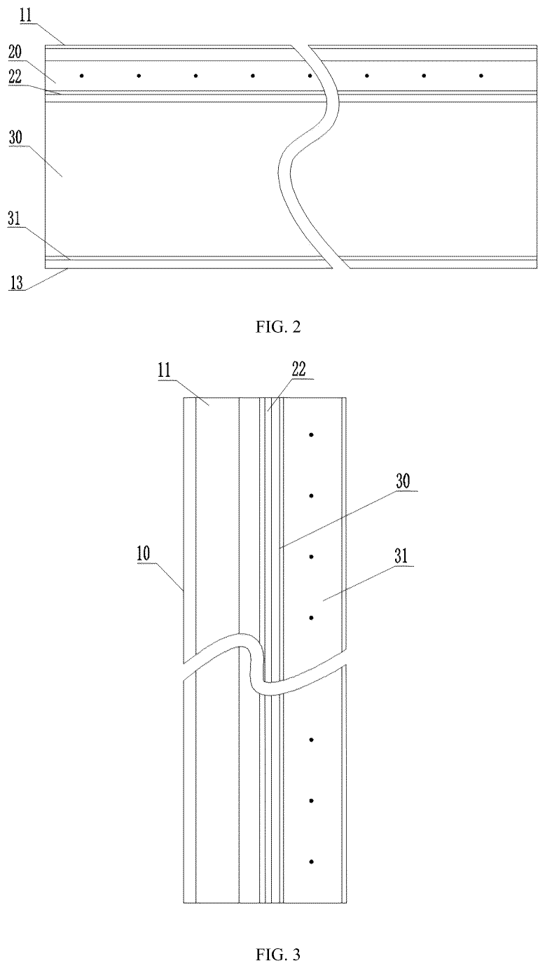

Referring to FIG. 2, in order to improve the rigidity and strength of the high-strength steel cold-formed profile for a photovoltaic module frame of the present invention, a plurality of welding points are evenly distributed longitudinally on the small horizontal wall 20 of the small U-shaped portion and the corresponding large horizontal wall 10 of the large U-shaped portion, thereby fixing the small horizontal wall 20 of the small U-shaped portion and the corresponding large horizontal wall 10 of the large U-shaped portion together longitudinally.

Referring to FIG. 3, in order to further improve the rigidity and strength of the high-strength steel cold-formed profile for a photovoltaic module frame of the present invention, an extended edge 13 is provided by processing on the out edge of the large lower vertical wall 14 of the large U-shaped portion, and welding points are evenly distributed longitudinally on the extended edge 13 and the horizontal wall 31 of the L-shaped portion, so as to fix the extended edge 13 of the outer edge of the large lower vertical wall 14 of the large U-shaped portion and the horizontal wall 31 of the L-shaped portion together longitudinally.

To facilitate mounting, save steel, and reduce production costs, the extended edge 13 and the horizontal wall 31 of the L-shaped portion are integrated with each other in an overlapping manner, so that the horizontal wall 31 of the L-shaped portion is parallel to the extended edge 13 of the outer edge of the large lower vertical wall 14.

The high-strength steel cold-formed profile for a photovoltaic module frame of the present invention is processed from a whole roll of steel strip through the steps of cutting, bending, rolling and welding.

According to another embodiment of the present invention, as shown in FIG. 4, a photovoltaic module frame is provided, which includes:

A large U-shaped portion; a small U-shaped portion embedded in the large U-shaped portion; an L-shaped portion connected to a lower side of the small U-shaped portion, the large U-shaped portion, the small U-shaped portion, and the L-shaped portion forming a cavity 40. Specifically, a cavity 40 is formed by the small lower vertical wall 22 of the small U-shaped portion and the large lower vertical wall 14 of the large U-shaped portion on an opposite side, as well as the vertical wall 30 of the L-shaped portion and the large horizontal wall 10 of the large U-shaped portion on an opposite side.

As shown in FIG. 4, the large U-shaped portion is arranged horizontally, with its U-shaped opening facing right, and the opening of the small U-shaped portion faces the same direction as the opening of the large U-shaped portion. The small U-shaped portion for accommodating the edge of the laminate for a photovoltaic module is embedded in the inner side of the large U-shaped portion.

Referring to FIGS. 1 and 4, the large U-shaped portion includes the large upper vertical wall 11, the large horizontal wall 10, the large lower vertical wall 14, and the extended edge 13; in the embodiment of the present invention, the large horizontal wall 10 serves as the “U-shaped bottom” of the large U-shaped portion.

The small U-shaped portion includes the small upper vertical wall 21, the small horizontal wall 20, and the small lower vertical wall 22; in the description of the present invention, the small horizontal wall 20 serves as the “U-shaped bottom” of the U-shaped portion.

The small upper vertical wall 21 and the small horizontal wall 20 of the small U-shaped portion are freely abutted against the large upper vertical wall 11 and a upper part 101 of the large horizontal wall 10 of the large U-shaped portion, respectively. The large upper vertical wall 11 of the large U-shaped portion is provided by processing with an outer convex edge protruding from the outer edge of the small upper vertical wall 21 of the small U-shaped portion, and the outer convex edge is bent downward and inward by 180 degrees to form a rim 12 under the outer edge of the small upper vertical wall 21 of the small U-shaped portion. The left end face of the rim 12 faces toward the inner side of the small U-shaped portion.

Furthermore, the small upper vertical wall 21 of the small U-shaped portion corresponding to the outer edge of the rim 12 and the large upper vertical wall 11 of the large U-shaped portion are both provided by processing with a downward inclination angle in a longitudinal direction. The downward inclination angle refers to the angle between the rim 12 and the horizontal plane; optionally, the downward inclination angle may be any angle not greater than 10 degrees, such as 5 degrees or 8 degrees, etc.

Furthermore, the small horizontal wall 20 of the small U-shaped portion and the upper part 101 of the large horizontal wall of the large U-shaped portion are fastened and connected at their overlapping part by a predetermined interlayer welding structure; the area where the interlayer welding structure is located is shown as the first and second dotted line areas 70 and 80 in FIG. 4.

When the small upper vertical wall 21 and the small horizontal wall 20 are in a state of being freely abutted against the upper vertical wall 11 and the upper part of the large horizontal wall 10, respectively and in a case where the length of the entire photovoltaic module frame is long, if external torque or a large weight is applied, misalignment, twisting, or sliding may occur between the small upper vertical wall 21 and the large upper vertical wall 11, and between the small horizontal wall 20 and the upper part 101 of the large horizontal wall 10, causing the entire frame to twist and tilt and making it unstable. Therefore, the present invention can prevent twisting and enhance the strength and stability of the entire frame by fastening and connecting the small horizontal wall 20 of the small U-shaped portion and the upper part 101 of the large horizontal wall of the large U-shaped portion at their overlapping parts by the predetermined interlayer welding structure.

Further, the large lower vertical wall 14 of the large U-shaped portion has an extended edge 13 on an outer edge thereof, and the extended edge 13 and the horizontal wall 31 of the L-shaped portion are fastened and connected at their overlapping part by a predetermined interlayer welding structure, and the area where the interlayer welding structure is located is shown as 80 in FIG. 4. The principle is the same as described above. The present invention can significantly enhance the torsion resistance of the entire frame by fastening and connecting the extended edge 13 and the horizontal wall 31 of the L-shaped portion at their overlapping part by a predetermined interlayer welding structure.

Furthermore, the predetermined interlayer welding structure refers to an interlayer connection structure formed by welding a first surface material and a second surface material at their overlapping part; wherein a welding depth of the welding area in the second surface material is controlled to be less than a predetermined depth.

In this embodiment, as shown in FIG. 4, the first surface material is the small horizontal wall 20, and the second surface material is the upper part 101 of the large horizontal wall 10; the area where the interlayer welding structure is located, i.e., the welding area, is shown as a first area 70 or a second area 80 indicated by the dotted line in FIG. 4. The first area 70 is the area where the two layers of materials, the small horizontal wall 20 and the upper part 101 of the large horizontal wall, are welded together, and includes a first welding area 701 located in the small horizontal wall 20 and a second welding area 702 located in the upper part 101 of the large horizontal wall; the small horizontal wall 20 and the upper part 101 of the large horizontal wall are welded together by the above interlayer welding structure, thereby enhancing the strength of the frame.

For the interlayer welding structure of the overlapping part of the extended edge 13 and the horizontal wall 31 of the L-shaped portion, the first surface material is the horizontal wall 31 of the L-shaped portion, and the second surface material is the extended edge 13; the second area 80 is the area where the two layers of materials, the horizontal wall 31 of the L-shaped portion and the extended edge 13, are welded together, and includes a third welding area 801 located in the horizontal wall 31 of the L-shaped portion and a fourth welding area 802 located in the extended edge 13. The horizontal wall 31 of the L-shaped portion and the extended edge 13 are welded together by the above interlayer welding structure, thereby further enhancing the strength of the frame.

Provision of both the two interlayer welding structures in the first area 70 and the second area 80, the strength of the frame is enhanced in both the vertical and horizontal directions, so that the frame has higher torsion resistance, and the overall strength of the frame is further improved.

Furthermore, in the present invention, the welding depth of the welding area in the second surface material is controlled to be less than a predetermined depth, and the predetermined depth is less than the thickness of the second surface material.

In this embodiment, as shown in FIG. 4, the second surface material is the upper part 101 of the large horizontal wall 10, and the depth D of the second area 702 of the welding area in the upper part 101 of the large horizontal wall 10 is less than the material thickness of the upper part 101 of the large horizontal wall 10, so that the upper part 101 of the large horizontal wall 10 can be prevented from protruding outward during welding, which may cause deformation of the frame. Preferably, the depth D may be, for example, less than or equal to 1/2 or 1/3 of the thickness of the second surface material. In one embodiment, the depth does not exceed 4/5 of the thickness of the second surface material. Similarly, for the area where the two layers of material, the horizontal wall 31 of the L-shaped portion and the extended edge 13, are welded together, the depth D of the fourth area 802 in the extended edge 13 of the second surface material is also set to be less than or equal to ½ or ⅓ of the thickness of the second surface material, or may be set to a predetermined depth less than ⅘ of the thickness of the second surface material, so as to prevent as much as possible the welding area penetrating too deeply in the second surface material, which causes protrusion on the outer wall surface of the second surface material.

In the embodiments of the present invention, the welding method includes arc welding, laser welding, and the like.

Further, in this embodiment, the welding direction selected during welding is from the first surface material to the second surface material. For example, during welding of the interlayer welding structure in the first region 70, welding is performed from the small horizontal wall 20 of the first surface material toward the upper part 101 of the large horizontal wall of the second surface material, thereby ensuring that the outer part of the upper part 101 of the large horizontal wall of the second surface material is not distorted and deformed due to the welding points. During welding of the interlayer welding structure in the second region 80, welding is performed from the horizontal wall 31 of the L-shaped portion of the first surface material toward the extended edge 13 of the second surface material, thereby ensuring that the outer part of the extended edge 13 of the second surface material is not distorted and deformed due to the welding points.

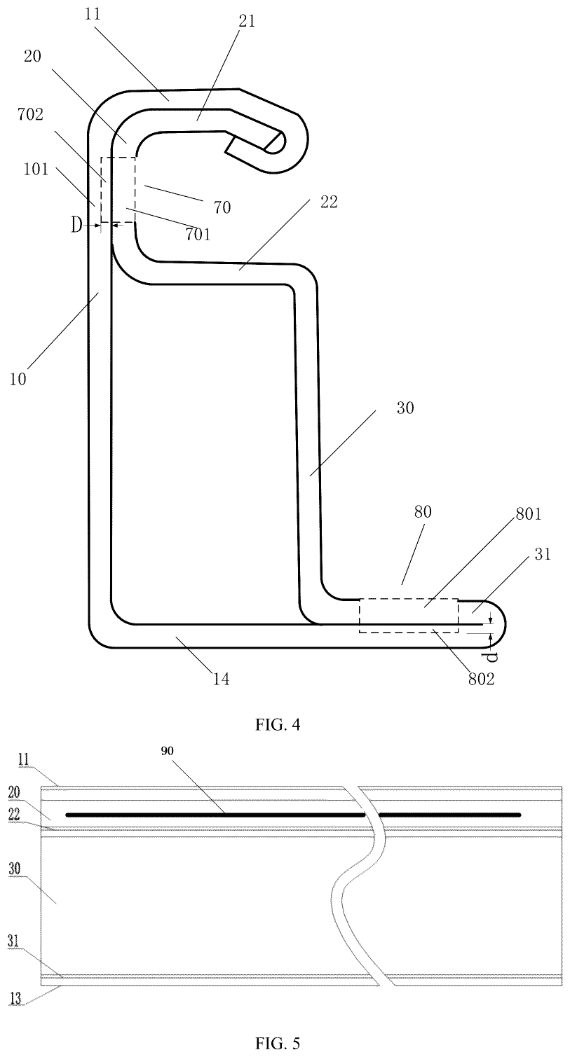

Referring to FIGS. 5-13, according to an embodiment of the present invention, the form of the predetermined interlayer welding structure can be selectively set to a variety of forms, including: a complete straight line segment, multiple straight line segments distributed at intervals, multiple complete straight line segments arranged in parallel, multiple straight line segments distributed at intervals and arranged in parallel; a combination of multiple straight line segments distributed at intervals and a complete straight line segment; or, the form of the predetermined interlayer welding structure is a zigzag line, an S-shaped line, or a dotted distribution.

According to an embodiment of the present invention, as shown in FIG. 5, which is a right side view of the frame in FIG. 3, the predetermined interlayer welding structure is set in a form of a complete straight line segment 90, and the interlayer welding structure is set along the center line of the small horizontal wall 20. The appearance after welding is shown as a complete straight line segment 90 in FIG. 5. The small horizontal wall 20 of the U-shaped portion and the upper part 101 of the large horizontal wall are welded together through the welding structure in the form of the complete straight line segment, thereby enhancing the strength and torsion resistance of the frame.

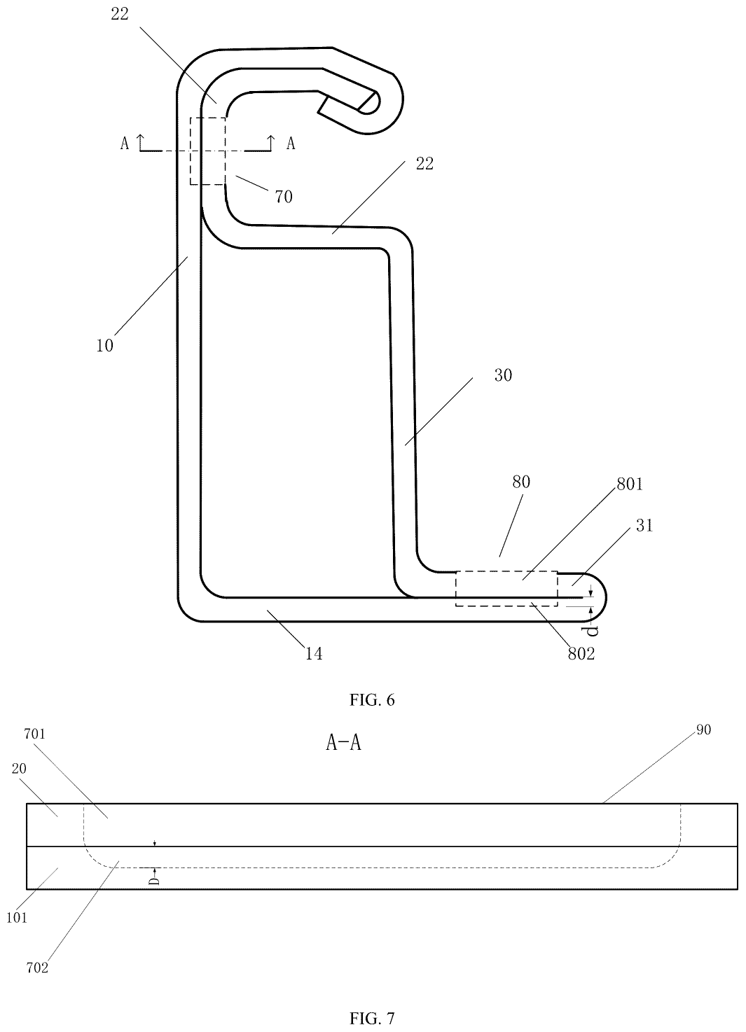

Further referring to FIG. 6, in which the cross-section A-A is marked at the first area 70, and referring to FIG. 7, which is a cross-sectional view of the section at the A-A position in FIG. 6, but for the convenience of viewing, the schematic view in FIG. 7 is a view of the cross-sectional view of A-A section rotated 90 degrees to the left, that is, to a horizontal position. In these figures, an interlayer welding structure is formed in the first area 70, the interlayer welding structure including a first area 701 arranged on the small horizontal wall 20, and a second area 702 arranged in the upper part 101 of the large horizontal wall. The welding depth of the second area in the upper part 101 of the large horizontal wall is D.

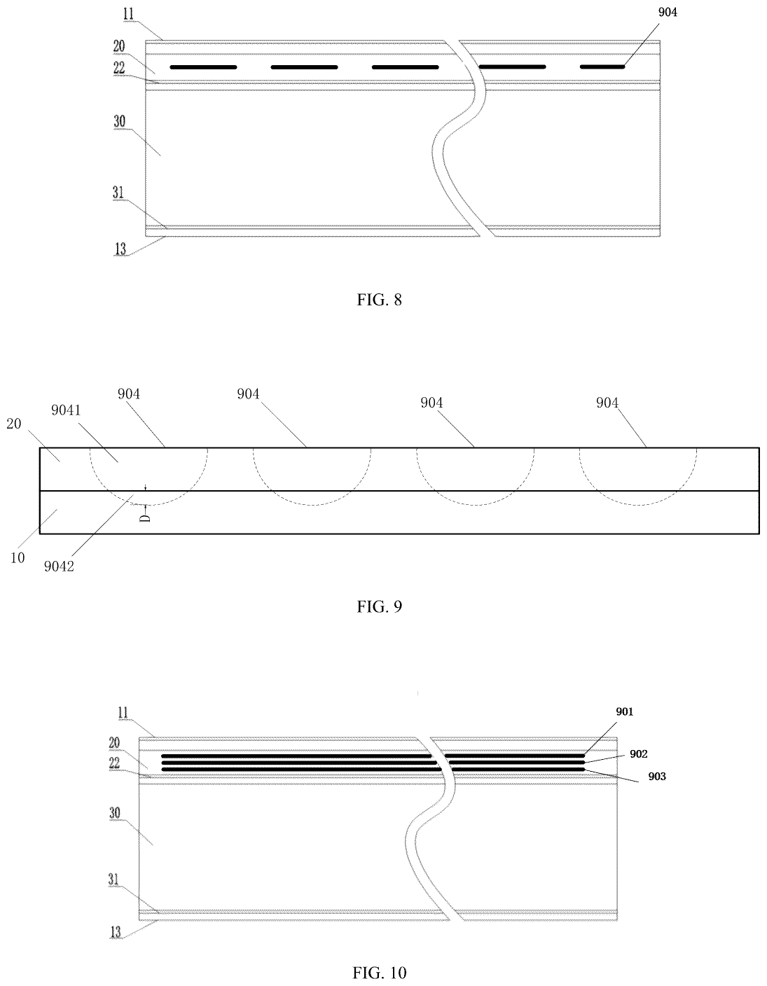

According to another embodiment of the present invention, as shown in FIG. 8, the predetermined interlayer welding structure is set in the form of multiple straight line segments 904 distributed at intervals, and the multiple straight line segments 904 distributed at intervals are set along the center line of the small horizontal wall 20. The appearance after welding is shown as the multiple straight line segments 904 distributed at intervals in FIG. 9. The small horizontal wall 20 of the U-shaped portion and the upper part 101 of the large horizontal wall are welded together through the welding structure in the form of multiple straight line segments distributed at intervals, thereby enhancing the strength and torsion resistance of the frame. Since there are intervals between the multiple straight line segments distributed at intervals, the stress deformation of the small horizontal wall 20 caused by welding can be reduced, and the welding point area is reduced, which can also save welding cost.

Further referring to FIG. 9, the multiple straight line segments 904 distributed at intervals can be observed on the surface of the small horizontal wall 20, and an interlayer welding structure is shown below the multiple straight line segments 904 distributed at intervals. The interlayer welding structure includes a plurality of first sub-regions 9041 arranged in the small horizontal wall 20, and a plurality of second sub-regions 9042 arranged in the upper part 101 of the large horizontal wall. The welding depth of the second sub-regions in the upper part 101 of the large horizontal wall is D.

Further, referring to FIG. 10, which is a schematic view of the interlayer welding structure in a form of multiple complete straight line segments, in which multiple complete straight line segments 901, 902, and 903 are arranged in parallel along the longitudinal region of the small horizontal wall 20. The small horizontal wall 20 of the U-shaped portion and the upper part 101 of the large horizontal wall are welded together through the welding structure in the form of multiple complete straight line segments arranged in parallel, thereby enhancing the strength and torsion resistance of the frame. Due to the use of the welding structure in the form of multiple complete straight line segments arranged in parallel, the welding strength is greater than that of a welding structure in the form of a complete straight line segment, and thus the welding is more stable.

Further, according to an optional embodiment, the following may also be selected and used: multiple straight line segments distributed at intervals and arranged in parallel, or a combination of multiple straight line segments distributed at intervals and a complete straight line segment, such as the case shown in FIG. 11, which is a schematic view of a combination of a complete straight line segment and straight line segments distributed at intervals on both sides thereof.

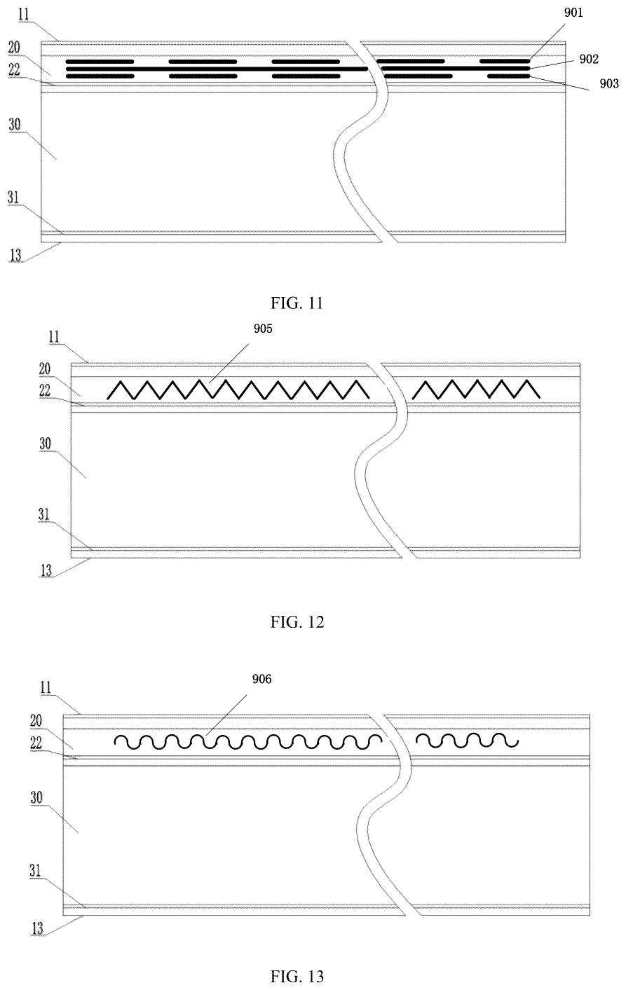

Further, according to an optional embodiment, as the form of the predetermined interlayer welding structure, a form of a zigzag line, an S-shaped line, or a dotted distribution can also be selected. FIG. 12 is a schematic view of an interlayer welding structure in the form of a zigzag line, which shows a zigzag line 905. FIG. 13 is a schematic view of an interlayer welding structure in the form of an S-shaped line, which shows an S-shaped line 906. The zigzag line 905 or the S-shaped line 906 can also effectively achieve the welding of the small horizontal wall 20 of the U-shaped portion and the upper part 101 of the large horizontal wall, thereby enhancing the strength and torsion resistance of the frame. In this way, a compromising effect can be obtained between the welding cost and welding strength.

According to another embodiment of the present invention, the above-mentioned predetermined interlayer welding structures are also applied for the interlayer welding structure between the horizontal wall 31 of the L-shaped portion and the extended edge 13, which is not described in detail herein.

Furthermore, the large upper vertical wall 11 of the large U-shaped portion has, on the outer edge thereof, the outer convex edge protruding from the outer edge of the small upper vertical wall 21 of the small U-shaped portion, and the outer convex edge is bent to wrap around the small upper vertical wall 21 of the small U-shaped portion to form the rim 12, so that a sealant overflow gap 50 is formed between the small upper vertical wall 21 of the small U-shaped portion within the rim 12 and the upper surface of the edge of the laminate 60 of the photovoltaic module during mounting. In this embodiment, the end of the rim 12 faces toward the inner side of the small U-shaped portion, so that the sealant can be effectively blocked from overflowing from a sealant overflow groove in actual use. In view of the fact that the traditional inclined sealant overflow groove is prone to overflowing, the present invention further uses the end face of the rim 12 to block the sealant, which provides a better effect.

Furthermore, the large U-shaped portion, the small U-shaped portion, and the L-shaped portion are integrally formed using a piece of plate, in which the horizontal wall 31 of the L-shaped portion and the extended edge 13 of the large U-shaped portion are an overlapping structure formed by folding the plate in half; and ends of the folded plate on both sides finally converge and is connected with each other at the rim.

Furthermore, the plate described in the present invention is a steel plate or a magnesium-aluminum-zinc-plated steel plate.

Furthermore, the depth of the welding area in the second surface material is controlled so that the second surface material has no protrusions on its outer wall.

Although the illustrative specific embodiments of the present invention are described to facilitate those skilled in the art to understand the present invention, and it should be appreciated that the present invention is not limited to the scope of the specific embodiments. As long as various changes are within the spirit and scope of the present invention as defined and determined by the attached claims, these changes are obvious to those of ordinary skill in the art, and all inventions and creations using the concept of the present invention are protected.

What is claimed is:

1. A high-strength steel cold-formed profile for a photovoltaic module frame, comprising an outer side portion and an inner side portion; the outer side portion comprising a large U-shaped portion arranged horizontally with an open side of the large U-shaped portion facing inward; the inner side portion comprising a small U-shaped portion for accommodating an edge of a laminate of a photovoltaic module; a small upper vertical wall and a small horizontal wall of the small U-shaped portion being abutted against a large upper vertical wall and an upper part of a large horizontal wall of the large U-shaped portion, respectively; an L-shaped portion being located below the small U-shaped portion, and an upper edge of a vertical wall of the L-shaped portion being integrated with an outer edge of a small lower vertical wall of the small U-shaped portion; wherein a cavity being formed by the small lower vertical wall of the small U-shaped portion and the large lower vertical wall of the large U-shaped portion on an opposite side, as well as the vertical wall of the L-shaped portion and the large horizontal wall of the large U-shaped portion on an opposite side; wherein
welding points are evenly distributed longitudinally on the small horizontal wall of the small U-shaped portion and a corresponding large horizontal wall of the large U-shaped portion; and the large lower vertical wall of the large U-shaped portion has an extended edge on an outer edge of the large lower vertical wall, and welding points are evenly distributed longitudinally on the extended edge and a horizontal wall of the L-shaped portion.

2. The high-strength steel cold-formed profile for the photovoltaic module frame according to claim 1, wherein the extended edge and the horizontal wall of the L-shaped portion are integrated with each other in an overlapping manner, wherein the horizontal wall of the L-shaped portion is parallel to the extended edge of the outer edge of the large lower vertical wall.

3. The high-strength steel cold-formed profile for the photovoltaic module frame according to claim 1, wherein the large upper vertical wall of the large U-shaped portion has, on an outer edge of the large upper vertical wall, an outer convex edge protruding from an outer edge of the small upper vertical wall of the small U-shaped portion, and the outer convex edge is bent downward and inward by 180 degrees to form a rim under the outer edge of the small upper vertical wall of the small U-shaped portion, wherein a sealant overflow gap is formed between the small upper vertical wall of the small U-shaped portion within the rim and an upper surface of the edge of the laminate of the photovoltaic module during mounting.

4. The high-strength steel cold-formed profile for the photovoltaic module frame according to claim 3, wherein the small upper vertical wall of the small U-shaped portion corresponding to an outer edge of the rim and the large upper vertical wall of the large U-shaped portion corresponding to the outer edge of the rim both have a downward inclination angle in a longitudinal direction.

5. The high-strength steel cold-formed profile for the photovoltaic module frame according to claim 4, wherein the downward inclination angle is less than or equal to 10 degrees.

6. The high-strength steel cold-formed profile for the photovoltaic module frame according to claim 4, wherein the downward inclination angle is 10 degrees.

7. The high-strength steel cold-formed profile for the photovoltaic module frame according to claim 1, wherein the cavity has a rectangular cross section, and a height of the cavity is greater than a width of the cavity.

8. The high-strength steel cold-formed profile for the photovoltaic module frame according to claim 1, wherein a cross section of the cavity is square.

9. A photovoltaic module frame, comprising:
a large U-shaped portion; a small U-shaped portion embedded in the large U-shaped portion; an L-shaped portion connected to a lower side of the small U-shaped portion, the large U-shaped portion, the small U-shaped portion, and the L-shaped portion forming a cavity; wherein
a small upper vertical wall and a small horizontal wall of the small U-shaped portion are respectively abutted against a large upper vertical wall and an upper part of a large horizontal wall of the large U-shaped portion;
the small horizontal wall of the small U-shaped portion and the large horizontal wall of the large U-shaped portion are fastened and connected at an overlapping part of the small horizontal wall and the large horizontal wall by a predetermined interlayer welding structure; and
a large lower vertical wall of the large U-shaped portion has an extended edge on an outer edge of the large lower vertical wall, and the extended edge and a horizontal wall of the L-shaped portion are fastened and connected at an overlapping part of the extended edge and the horizontal wall by a predetermined interlayer welding structure.

10. The photovoltaic module frame according to claim 9, wherein
the predetermined interlayer welding structure is an interlayer connection structure formed by welding a first surface material and a second surface material at an overlapping part of the first surface material and the second surface material; wherein a welding depth of a welding area in the second surface material is controlled to be less than a predetermined depth.

11. The photovoltaic module frame according to claim 10, wherein
the predetermined depth is less than a thickness of the second surface material, and a welding direction is from the first surface material to the second surface material.

12. The photovoltaic module frame according to claim 9, wherein
the predetermined interlayer welding structure is in a form of a complete straight line segment, a plurality of straight line segments distributed at intervals, a plurality of complete straight line segments arranged in parallel, or a plurality of straight line segments distributed at intervals and arranged in parallel; or a combination of a complete straight line segment and a plurality of straight line segments distributed at intervals and arranged in parallel; or
the predetermined interlayer welding structure is in a form of a zigzag line, an S-shaped line, or a dotted distribution.

13. The photovoltaic module frame according to claim 9, wherein
the large upper vertical wall of the large U-shaped portion has, on an outer edge of the large upper vertical wall, an outer convex edge protruding from an outer edge of the small upper vertical wall of the small U-shaped portion, and the outer convex edge is bent to wrap around the small upper vertical wall of the small U-shaped portion to form a rim, wherein an sealant overflow gap is formed between the small upper vertical wall of the small U-shaped portion within the rim and an upper surface of the edge of the laminate of the photovoltaic module during mounting.

14. The photovoltaic module frame according to claim 13, wherein
the large U-shaped portion, the small U-shaped portion, and the L-shaped portion are integrally formed using a piece of plate, wherein the horizontal wall of the L-shaped portion and the extended edge of the large U-shaped portion are an overlapping structure formed by folding the plate in half; and ends of a folded plate on both sides converge and is connected with each other at the rim.

15. The photovoltaic module frame according to claim 14, wherein
the plate is a steel plate or a magnesium-aluminum-zinc-plated steel plate.

16. The photovoltaic module frame according to claim 9, wherein
the depth of the welding area in the second surface material is controlled so that the second surface material has no protrusions on an outer wall of the second surface material.

17. The photovoltaic module frame according to claim 9, wherein
the small U-shaped portion accommodates the edge of the laminate of the photovoltaic module, and an L-shaped portion is located below the small U-shaped portion; the L-shaped portion is connected to the lower side of the small U-shaped portion, and the large U-shaped portion, the small U-shaped portion, and the L-shaped portion form a cavity, wherein:
a cavity is formed by a small lower vertical wall of the small U-shaped portion and the large lower vertical wall of the large U-shaped portion on an opposite thereof, as well as a vertical wall of the L-shaped portion and the large horizontal wall of the large U-shaped portion on an opposite thereof.

18. The photovoltaic module frame according to claim 11, wherein the predetermined depth is ½ or ⅓ of the thickness of the second surface material; or the predetermined depth is less than ⅘ of the thickness of the second surface material.

19. The photovoltaic module frame according to claim 9, wherein a welding method comprises arc welding or laser welding.

20. The photovoltaic module frame according to claim 11, wherein the welding direction is from the first surface material to the second surface material, comprising:
welding the overlapping part of the small horizontal wall of the small U-shaped portion and the large horizontal wall of the large U-shaped portion from a side of the small horizontal wall of the small U-shaped portion to a side of the large horizontal wall of the large U-shaped portion; and
welding the overlapping part of the extended edge and the horizontal wall of the L-shaped portion from the horizontal wall of the L-shaped portion to the extended edge.
